(19) United States
(12) Patent Application Publication
(10) Pub. No.: US 2010/0176780 A1
(43) Pub. Date: Jul. 15, 2010

(54) Power supply device and electronic apparatus

(75) Inventors: Yoshito Koyama, Kawasaki (JP); Minoru Hirahara, Kawasaki (JP); Seiji Miyoshi, Kawasaki (JP); Eiji Miyachika, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/659,728

(22) Filed: Mar. 18, 2010

Related U.S. Application Data
(63) Continuation of application No. PCT/JP2007/068194, filed on Sep. 19, 2007.

(51) Int. Cl. G05F 1/10

(52) U.S. Cl. 323/282

(57) ABSTRACT

A power supply device includes: a power supply connector which receives supply of power and supplies the power to the outside thereof; plural OBPs which apply voltages to supply power, to each of processing devices to perform processing and to include different types of application voltages planned to be applied, and each of the plural OBPs is supplied with power directly or indirectly from the power supply connector; and a power supply control section that increases and decreases supplying power which each of the OBPs supplies to one processing device out of the plural processing devices according to an extent of a processing load in the one processing device as well as according to an extent of a processing load in another processing device whose application voltage is different from that of the one processing device.

### CROSS-REFERENCE TO RELATED APPLICATION

This is a continuation application of PCT/JP2007/068194, filed on Sep. 19, 2007.

### TECHNICAL FIELD

The embodiment discussed herein is related to a power supply device that supplies power to a processing device and an electronic apparatus mounted with the power supply device.

### BACKGROUND ART

Conventionally, in an electronic apparatus such as a communication device and a server device, there is provided a power supply device that supplies power to an IC or the like that executes various types of processing. Such power supply device is required of supplying stable power consistently, and in particular, required of adjusting an output voltage that is outputted to an IC or the like to be constant.

FIG. 1 schematically illustrates a structure of a power supply device that supplies power to an electronic apparatus.

A power supply device 10 illustrated in FIG. 1 is a power supply device employing an analog control method in which an output voltage to an IC or the like is controlled with the use of an analog component such as an amplifier and a comparator.

The power supply device 10 includes a voltage detection circuit 11, an error amplifier 12, a compensation circuit 13, a reference oscillator 14, a comparator 15, a switch element 16, a smoothing filter 17 and so on.

Firstly, in the voltage detection circuit 11, a power output voltage Vout that is currently outputted from the power supply device 10 to an IC or the like is detected, and the detected output voltage Vout is transmitted to the error amplifier 12. In the error amplifier 12, a difference between the output voltage Vout and a reference voltage V0 is amplified and outputted. In the compensation circuit 13, an amplified voltage Vg that is outputted from the error amplifier 12 is adjusted to a value appropriate to the sensitivity of the comparator 15.

In the reference oscillator 14, a voltage signal Vp of sawtooth waveform is outputted at a given frequency. In the comparator 15, the voltage signal Vp of sawtooth waveform outputted from the reference oscillator 14 is compared with the amplified voltage Vg that has been adjusted in the compensation circuit 13, and a control signal that becomes “ON” while the voltage signal Vp of sawtooth waveform is smaller than the amplified voltage Vg, and becomes “OFF” at all other times is transmitted to the switch element 16.

In the switch element 16, since “ON-OFF” is thus controlled by the control signal transmitted from the comparator 15, a pulse width of the input voltage Vin that has been inputted to the power supply device 10 is adjusted, and a smoothing operation is executed in the smoothing filter 17. As a consequence, the output voltage Vout whose voltage value has been adjusted is outputted from the power supply device 10 to an electronic apparatus. For example, if the output voltage Vout detected in the voltage detection circuit 11 drops, an error between the output voltage Vout and the reference voltage V0 which is calculated in the error amplifier 12 becomes large. As a consequence, the voltage signal Vp of sawtooth waveform becomes smaller than the amplified voltage Vg, causing “ON” duration of the control signal outputted from the comparator 15 longer, so that the pulse width of the input voltage Vin is adjusted to be longer and the output voltage Vout is raised.

In the power supply device 10, the output voltage that is outputted to a processing section is controlled to be constant as described above.

Here, in an electronic apparatus, various kinds of components, an IC and the like included in the electronic apparatus is supplied with power to operate. In these components, the IC and the like, a power consumption changes in accordance with an amount of load in processing shared by each of the components, the IC and the like. If such individual fluctuation of load is moderate, it is possible to supply required power consistently by absorbing the fluctuation of load in each component and thus maintaining a voltage to be applied to the components and the IC or the like to be constant. However, in a communication device or a server device among the electronic apparatuses, there is a case in which a load in the IC or the like that executes communication processing abruptly fluctuates in synchronization with a state of communications traffic, which makes it difficult to absorb abrupt fluctuations of load in such a local place under an overall control by a single power supply device.

For this reason, there is proposed a technique that absorbs local fluctuations of load individually and maintains necessary power supply independently by providing plural power supply devices in such a manner that at least one power supply device is disposed near various kinds of components, an IC and the like included in an electronic apparatus, and by individually controlling voltage to be applied to the various kinds of components, the IC and the like (see U.S. Pat. No. 6,646,425, for example).

However, even if the voltage to be applied to the various kinds of components, the IC and the like is controlled individually by the technique disclosed in the U.S. Pat. No. 6,646,425, in a case where fluctuations of load in a component that adjoins a component targeted for controlling by a power supply device are too large, there often occurs a problem that the power supply device may not be able to maintain proper power supply to the control target, by being affected by the fluctuations of load in other component that is not targeted for controlling.

### DISCLOSURE OF INVENTION

According to an aspect of the invention, a power supply device includes:

a power supply section that receives supply of power and supplies the power to the outside thereof;

plural power supplies which apply voltages to supply power, to each of plural processing devices to perform processing by receiving application of a voltage and to include different types of application voltages planned to be applied, and each of the plural power supplies is supplied with power directly or indirectly from the power supply section; and

a power supply control section that increases and decreases supplying power to one processing device out of the plural processing devices according to an extent of a processing load in the one processing device as well as according to an extent of a processing load in another processing device whose application voltage is different from that of the one processing device.

Incidentally, the idea that the power supply control section increases and decreases supplying power to one processing device out of the plural processing devices includes both that the power is increased when a processing load in another processing device whose application voltage is different from that of the processing device is large and that, on the contrary, the power is decreased when the processing load is large.

The power to be supplied to the processing device by one power supply is affected by a processing load in another processing device whose application voltage is different from that of the one processing device, via the power supply section. As a result, when the power to be supplied is affected by a fluctuation of the load in another processing device that is not a power supply target, proper power supply may not be maintained. According to the power supply device of the aspect of the present invention, the power control is performed in accordance with an extent of a processing load in another processing device that is not the power supply target as well. As a consequence, for example, by increasing power to be supplied by one power supply when a load in another processing device that is not the power supply target is large, it is possible to control such that proper power supply is maintained by the power supply. Or conversely, by decreasing power to be supplied by one power supply when a load in another processing device that is not the power supply target is large, it is possible to control so as to help maintaining proper power supply to another processing device that is not the power supply target. And thus it is possible to effectively avoid the above-described problem. Namely, according to the power supply device of the aspect of the present invention, it is possible to preferably supply power to each of various kinds of components, an IC and the like included in an electronic apparatus (processing device).

In the aspect of the power supply device of the present invention, it is a preferable mode that “the power supply control section increases the supplying power to the one processing device, when the processing load in another processing device whose application voltage is different from that of the one processing device is larger than a predetermined load”.

According to the power supply device of this preferable mode, it is possible to effectively avoid a situation in which power to be supplied to a processing device becomes insufficient due to an influence of a large processing load in another processing device.

In the aspect of the power supply device of the present invention, it is also a preferable mode that “the power supply control section decreases the supplying power to the one processing device, when the processing load in another processing device whose application voltage is different from that of the one processing device is larger than a predetermined load”.

According to the power supply device of this preferable mode, it is possible to help recovering power supply to a processing device in which power shortage is expected, by decreasing power to be supplied to the processing device by the power supply when the power shortage is expected in the processing device due to a large processing load in another processing device.

In the aspect of the power supply device of the present invention, it is also a preferable mode that “the plural power supplies include: a first power supply that is directly supplied with power from the power supply section; and a second power supply that receives supply of power from the first power supply to apply a voltage lower than that of the first power supply to the one processing device, and the power supply control section increases supplying power which the second power supply supplies to the one processing device, when the processing load in another processing device to which the first power supply supplies power is larger than a predetermined load”.

In a processing system including plural processing devices, a processing device such as a CPU, for example, in which processing is concentrated is usually designed to operate by receiving application of a relatively low voltage for saving power, and as a result, in this processing device in which processing is concentrated is easily affected by a drop of the application voltage. On the other hand, a processing device in which concentration of processing rarely occurs operates under a relatively high application voltage and thus is tolerant to the drop of application voltage. According to the power supply device of this preferable mode, it is possible to effectively avoid a situation in which a processing load happens to become large in a processing device that receives application of a relatively high voltage from the first power supply, which affects to cause a power shortage in a processing device that receives application of a relatively low voltage from the second power supply device and eventually causes a system down.

In the aspect of the power supply device of the present invention, it is also a preferable mode that “the plural power supplies include: a first power supply that is directly supplied with power from the power supply section; and a second power supply that receives supply of power from the first power supply to apply a voltage lower than that of the first power supply to the one processing device, and the power supply control section decreases supplying power which the first power supply supplies to the one processing device, when the processing load in another processing device to which the second power supply supplies power is larger than a predetermined load”.

According to the power supply device of this preferable mode, in a case where a power shortage is expected to happen in a processing device that receives application of a relatively low voltage from the second power supply, it is possible to help maintaining power supply to the processing device by decreasing power to another processing device that receives application of a relatively high voltage from the first power supply.

According to another aspect of the invention, an electronic apparatus includes: plural processing devices each of which receives application of a voltage to perform processing, including different types of application voltages planned to be applied; and a power supply device including: a power supply section that receives supply of power and supplies the power to the outside thereof; plural power supplies which apply voltages to supply power, to each of the plural processing devices, and each of the plural power supplies is supplied with power directly or indirectly from the power supply section; and a power supply control section that increases and decreases supplying power to one processing device out of the plural processing devices according to an extent of a processing load in the one processing device as well as according to an extent of a processing load in another processing device whose application voltage is different from that of the one processing device.

According to the aspect of the electronic apparatus of the present invention, it is possible to supply power adequately to various kinds of components, an IC and the like included in the electronic apparatus, respectively. Incidentally, only a basic aspect is described for the electronic apparatus of the present invention. However, this is for the intention of avoiding redundancy, and the electronic apparatus of the present invention includes not only the basic aspect but also various kinds of modes corresponding to the previously described each mode of the power supply device.

According to the aspect of the present invention, it is possible to obtain a power supply device capable of supplying power adequately to various kinds of components, an IC and the like included in an electronic apparatus, respectively and an electronic apparatus mounted with the power supply device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram of a power supply device that supplies power to an electronic apparatus;

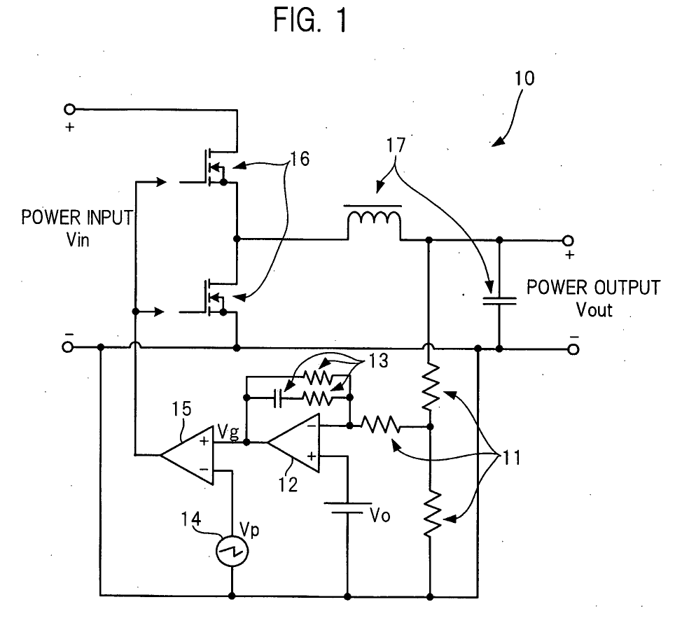

FIG. 2 is an external perspective view of a communication unit according to one embodiment of the present invention;

FIG. 3 is a perspective view of a holding plate 210 included in an electronic circuit package 200;

FIG. 4 is a schematic diagram of the electronic circuit package 200 in which a board 220 is attached to the holding plate 210;

FIG. 5 is a schematic functional block diagram of three electronic circuit packages 200_1, 200_2, and 200_3 among the plural electronic circuit packages illustrated in FIG. 2;

FIG. 6 is a diagram to explain a flow of power supply in a signal processing package 200_3;

FIG. 7 is a schematic diagram of a processing circuit 221_3, an OBP 223_3 that supplies power to the processing circuit 221_3, and a power control section 224_3 also illustrated in FIG. 5; and

FIG. 8 illustrates one example of another connection mode of OBPs, different from the connection mode illustrated in FIG. 6.

### BEST MODE FOR CARRYING OUT THE INVENTION

Exemplary embodiments of the present invention will be described with reference to the drawings.

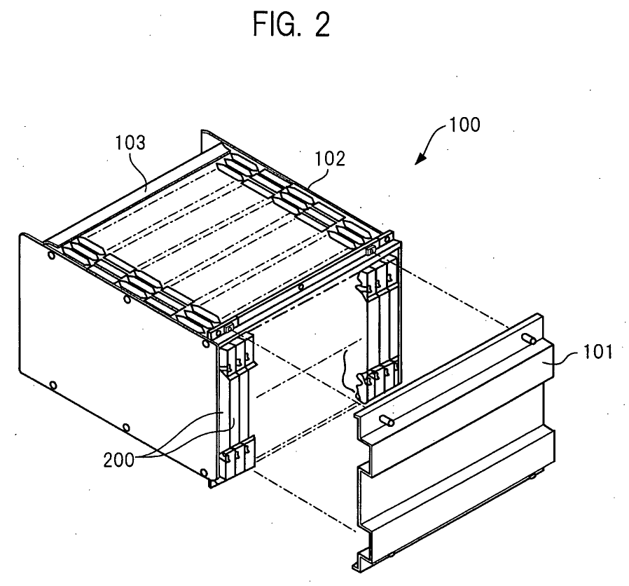

FIG. 2 is an external perspective view of a communication unit according to one embodiment of the present invention.

A communication unit 100 is one example of the electronic apparatus according to the present invention, which transmits and receives data via a network. The communication unit 100 includes a unit cover 101, a unit frame 102, a back panel 103, and plural electronic circuit packages 200 which execute processing, housed in a space enclosed with these cover, frame and back panel.

On an inside of the back panel 103, various kinds of connectors (not illustrated) to transmit data and power are provided. These connectors are engaged with connectors arranged in the plural electronic circuit packages 200, respectively, so that the plural electronic circuit packages 200 are connected to each other.

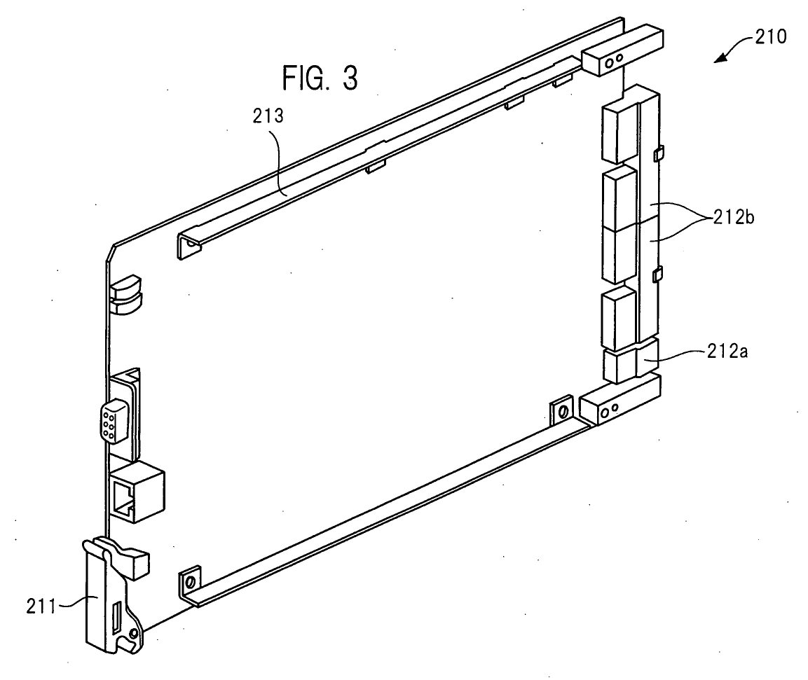

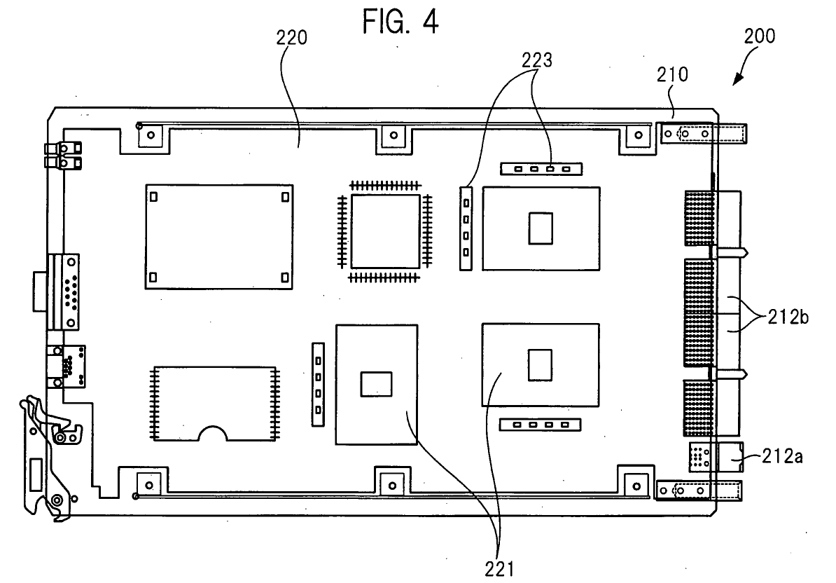

The plural electronic circuit packages 200 sequentially execute processing for communication data transmitted via a network, and in response to processing executed in an upstream electronic circuit package 200, processing in a downstream electronic circuit package 200 is started. Additionally, each electronic circuit package 200 includes a board 220 (see FIG. 4) to which an IC or the like is mounted and a holding plate 210 (see FIG. 3) for holding the board 220.

FIG. 3 is a perspective view of the holding plate 210 included in the electronic circuit package 200, and FIG. 4 is a schematic diagram of the electronic circuit package 200 in which the board 220 is attached to the holding plate 210.

The holding plate 210 includes a grip section 211 to be gripped with a hand when inserting and extracting the holding plate 210 to and from the unit frame 102 in FIG. 2, a power supply connector 212a to input power to the electronic circuit package 200, a curve preventing metal member 213 to prevent curving of the board 220, and data connectors 212b to transmit and receive various kinds of data and the like.

FIG. 4 illustrates the electronic circuit package 200 in a state in which the board 220 is attached to the holding plate 210. The board 220 is equipped with plural processing circuits 221 such as an IC, and OBPs 223 to supply power to each of the plural processing circuits 221. The board 220 is fitted into the holding plate 210, the power supply connector 212a and the data connectors 212b in the holding plate 210 are inserted into the board 220, and thereby the board 220 is attached to the holding plate 210. Furthermore, the holding plate 210 is fitted into the unit frame 102 illustrated in FIG. 2 to be connected to a connector in the back panel 103, and thus the plural electronic circuit packages 200 are connected to each other.

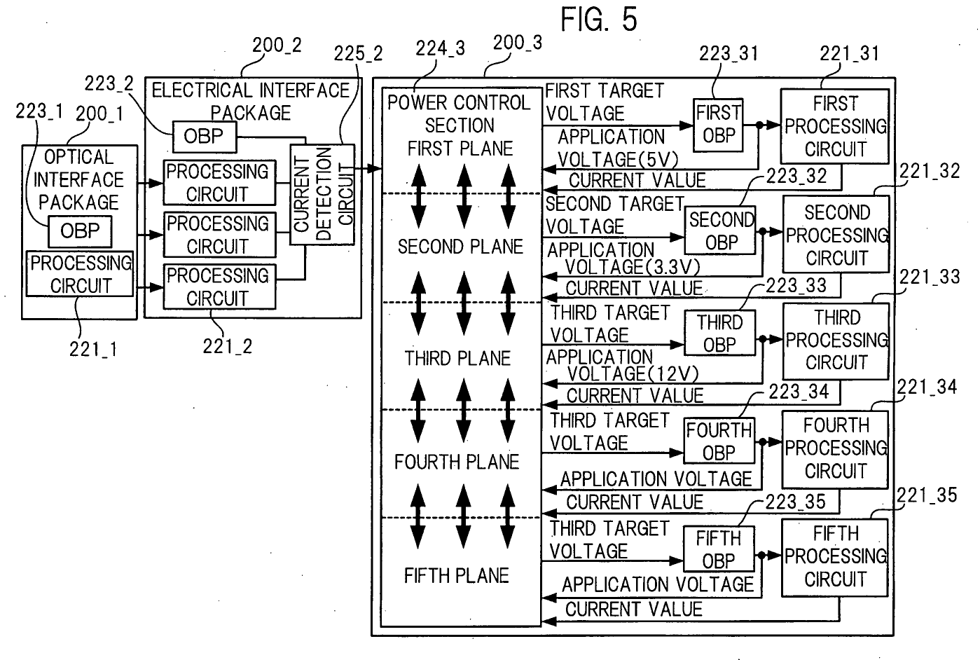

FIG. 5 is a schematic functional block diagram of three electronic circuit packages 200_1, 200_2, and 200_3 among the plural electronic circuit packages 200 illustrated in FIG. 2.

Hereafter, explanation will be made about various components included in three electronic circuit packages 200_1, 200_2, and 200_3 by identifying each by its last number.

FIG. 5 illustrates an optical interface package 200_1 that receives optical data transmitted via a network, an electrical interface package 200_2 that converts the optical data received in the optical interface package 200_1 into digital data, and a signal processing package 200_3 that subjects various kinds of signal processing to the digital data converted in the electrical interface package 200_2. In this embodiment, power is inputted to the entire communication unit 100 illustrated in FIG. 2, and after the power is distributed to each OBP 223 in plural electronic circuit packages 200, power is supplied to a processing circuit 221 from the OBP 223 in each of the electronic circuit package 200.

The electrical interface package 200_2 includes a current detection circuit 225_2 that detects a value of a current flowing into a processing circuit 221_2 when the processing is executed.

In the signal processing package 200_3, five types of processing circuits whose application voltages planned to be applied are different from each other are provided, each having a different expected. They are a first processing circuit 221_31 that operates by receiving an application voltage of a first application voltage (5V in the example of FIG. 5); a second processing circuit 221_32 that operates by receiving an application voltage of a second application voltage (3.3V in the example of FIG. 5); a third processing circuit 221_33 that operates by receiving an application voltage of a third application voltage (12V in the example of FIG. 5); a fourth processing circuit 221_34 that operates by receiving an application voltage of a fourth application voltage (which is not specified here, but a voltage larger than 5V); and a fifth processing circuit 221_35 that operates by receiving an application voltage of a fifth application voltage (which is not specified here, but a voltage larger than 5V). Among these five types of processing circuits, the first processing circuit 221_31 and the second processing circuit 221_32 operating under relatively low application voltages handle the entire control of the signal processing package 200_3 and communication processing, and are circuits in which processing is concentrated in the signal processing package 200_3. On the other hand, the third processing circuit 221_33 through the fifth processing circuit 221_35 are ones in which concentration of processing rarely occurs in the signal processing package 200_3.

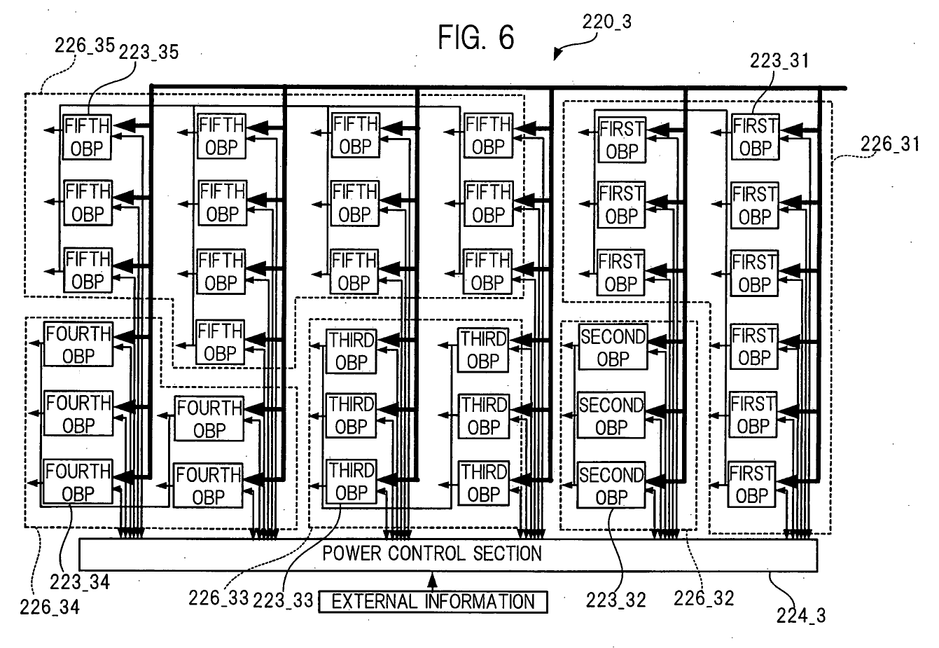

Furthermore, the signal processing package 200_3 includes five types of OBPs: a first OBP 223_31 for supplying power to the first processing circuit 221_31; a second OBP 223_32 for supplying power to the second processing circuit 221_32; a third OBP 223_33 for supplying power to the third processing circuit 221_33; a fourth OBP 223_34 for supplying power to the fourth processing circuit 221_34; and a fifth OBP 223_35 for supplying power to the fifth processing circuit 221_35. Here, in this embodiment, plural OBPs are provided for each type, as illustrated in FIG. 6 to be described later. However, in FIG. 5, only one OBP is illustrated for each type for the sake of easier understanding of the diagram.

The signal processing package 200_3 further includes a power control section 224_3 that detects an application voltage to be applied to a processing circuit by each OBP, and controls power supply in each OBP such that a difference is compensated between the detected application voltage and a target voltage.

In this power control section 224_3, a value of a current flowing into each type of processing circuit, which has been detected by a predetermined current detection circuit, is inputted for each of the five types of processing circuits. And based on these inputted values of the currents, a power consumption in each type of the processing circuits is calculated. The power control section 224_3 obtains the value of the current detected in the current detection circuit 225_2 of an upstream electrical interface package 200_2. Moreover in the power control section 224_3, five types of target voltages, which are a first target voltage used for a power control of the first OBP 223_31, a second target voltage used for a power control of the second OBP 223_32, a third target voltage used for a power control of the third OBP 223_33, a fourth target voltage used for a power control of the fourth OBP 223_34, and a fifth target voltage used for a power control of the fifth OBP 223_35 are calculated based on a processing load (power consumption) of each processing circuit and the value of the current obtained from the current detection circuit 225_2. Then, for each type of OBP, the above-described power control is executed by using the calculated target voltage. The power control section 224_3 is an example of the power supply control section of the present invention, each of the five types of OBPs is an example of the power supply of the present invention, and each of the five types of processing circuits is an example of the processing device of the present invention.

FIG. 6 is a diagram to explain a flow of power supply in the signal processing package 200_3. Incidentally, in FIG. 6, the five types of processing circuits illustrated in FIG. 5 are not illustrated for the sake of easier understanding of the diagram and only the five types of OBPs and the power control section 224_3 are illustrated.

As illustrated in this FIG. 6, in the signal processing package 200_3, plural OBPs form a group for each of the five types of processing circuits. In the signal processing package 200_3, plural OBPs belonging to a group supply power to each type of processing circuits via a power supply layer (plane) common to the group. In FIG. 6, the five types of planes are schematically illustrated in dotted lines. That is, the plural first OBPs 223_31 supply power to the first processing circuit 221_31 via a first plane 226_31, the plural second OBPs 223_32 supply power to the second processing circuit 221_32 via a second plane 226_32, the plural third OBPs 223_33 supply power to the third processing circuit 221_33 via a third plane 226_33, the plural fourth OBPs 223_34 supply power to the fourth processing circuit 221_34 via a fourth plane 226_314, and the plural fifth OBPs 223_35 supply power to the fifth processing circuit 221_35 via a fifth plane 226_35.

The power control section 224_3 controls power supply in each OBP 223_3 corresponding to each plane 226_3 such that a difference is compensated between an application voltage and a target voltage, which difference is generated by fluctuations of a load in each processing circuit 221_3.

At this time, the target voltage is calculated by the power control section 224_3 for each plane 226_3 in a manner as described later.

Here, in the signal processing package 200_3, all the OBPs 223_3 receive power supply from a not-illustrated common power supply via the power supply connector 212a in FIG. 4 and each generates power to be supplied to each processing circuit 221_3. The power supply connector 212a in FIG. 4 is one example of the power supply section according to the present invention. With this configuration, in the signal processing package 200_3, even among different types of OBPs 223_3 of the planes 226_3 whose types are different from each other, fluctuations of a load in the processing circuit 221_3 that is a power supply target of each OBP 223_3 affect to each other. As a result, it may be impossible to maintain proper power supply by being affected by fluctuations of a load in a power supply target of a different type of OBP 223_3. Therefore, the power control section 224_3 calculates a target voltage for one plane 226_3 not only according to a processing load in a processing circuit 221_3 corresponding to the one plane 226_3, but also according to a processing load in a processing circuit 221_3 corresponding to another plane 226_3, so that a mutual interference in the power control between the OBPs 223_3 of the planes 226_3 different from each other is suppressed.

Hereafter, calculation of a target voltage in the power control section 224_3 will be explained.

In this embodiment, calculation of a target voltage for one plane 226_3 is executed by using both of the feedback processing and the feedforward processing to be described later. Firstly, the feedback processing will be explained.

In the feedback processing in this embodiment, firstly in the processing circuit 221_3 in the plane 226_3 that is a calculation target of the target voltage, if a processing load that has been detected before the present time is larger than a predetermined load, the target voltage is calculated to be rather high in accordance with a difference between the detected processing load and the predetermined load.

Further, in this feedback processing, when calculating target voltages for planes, each for each of the first processing circuit 221_31 and the second processing circuit 221_32 whose application voltages are relatively low, in which processing is concentrated in the signal processing package 200_3, namely, for the first plane 226_31 and the second plane 226_32, if a processing load detected prior to the present time with respect to a processing circuit 221_3 of the other planes 226_3 other than the calculation target is larger than a predetermined value, the target voltage is calculated to be rather high according to the difference between the detected processing load and the predetermined load. On the other hand, when calculating target voltages for planes, each for each of the third processing circuit 221_33 through the fifth processing circuit 221_35 whose application voltages are relatively high, in which processing is rarely concentrated, namely, for the third plane 226_33 through the fifth plane 226_35, if a processing load detected prior to the present time with respect to the processing circuits 221_3 of the other planes 226_3 other than the calculation target, is larger than a predetermined value, the target voltage is calculated to be rather low according to the difference between the detected processing load and the predetermined load.

Next, the feedforward processing will be explained.

In this embodiment, among the plural processing circuits 221_3 in the signal processing package 200_3 illustrated in FIG. 5, the first processing device 221_31 and the second processing device 221_32 handle communication processing as described above, so that when an amount of communication data increases, processing loads of the first and second processing devices 221_31, 221_32 increase.

In the power control section 403_3, a value of a current obtained from the electrical interface package 200_2 is used as an index indicating the amount of communication data, and when the value of the current is larger than a predetermined value, target voltages for the first plane 226_31 and the second plane 226_32 are calculated to be rather high according to a difference between the value of the current and the predetermined value. Further, at this time, for the third 226_33 plane through the fifth plane 226_35, the target voltage is calculated to be rather low according to a difference between the value of the current and the predetermined value.

Next, a control of the application voltage using the target voltage which is thus calculated will be explained in detail.

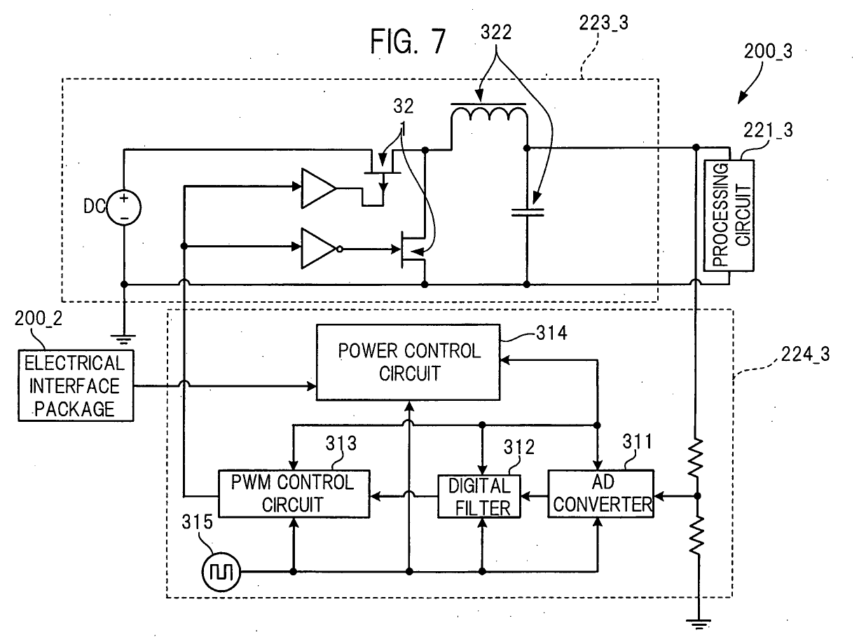

FIG. 7 is a schematic diagram of the processing circuit 221_3, the OBP 223_3 that supplies power to the processing circuit 221_3, and the power control section 224_3 also illustrated in FIG. 5.

Incidentally, in FIG. 7, for the sake of simplifying explanation, one processing circuit 221_3 and one OBP 223_3 are illustrated without their types.

As illustrated in FIG. 7, the power control section 224_3 includes an AD (Analog-Digital) converter 311, a digital filter 312, a PWM control circuit 313, a power control circuit 314, and a pulse generator 315. The OBP 223_3 includes a switch element 321, a smoothing filter 322 and the like.

When controlling power supply to the processing circuit 221_3, basically, in a similar manner as in a conventional analog power supply device, feedback processing is executed, in which power to be supplied later than the present time is controlled based on the power that has been supplied earlier than the present time.

First of all, in the AD converter 311, the voltage that has been applied to the processing circuit 221_3 from the OBP 223_3 earlier than the present time is detected, and the detected voltage is converted into a digital signal to be transmitted to the digital filter 312. The digital filter 312 calculates a difference between the detected voltage and the target voltage described above, averages the difference and generates an error signal. Here, the calculation of the target voltage is performed by using both the feedback processing and the feedforward processing, as described above.

This calculation is made in the power control section 314 and the calculated target voltage is transmitted to the digital filter 312.

The error signal generated in the digital filter 312 is transmitted to the PWM control circuit 313.

The PWM control circuit 313 generates a control signal having a pulse width in accordance with a control value transmitted from the power control section 314, based on a pulse signal generated from the pulse generator 315 and the error signal transmitted from the digital filter 312, and the generated control signal is transmitted to the switch element 321.

The switch element 321 controls ON-OFF according to the control signal transmitted from the PWM control circuit 313, and as a result, a pulse width of an input voltage is adjusted. Furthermore, a voltage whose pulse width has been adjusted passes through the smoothing filter 322, and thereby an application voltage is smoothed and power is supplied to the processing circuit 221_3.

For example, if the application voltage drops, a value of the error signal generated in the digital filter 312 becomes large and the control signal whose pulse width is large is generated in the power control circuit 314. As a result, a “ON” duration of the switch element 321 becomes longer, so that the application voltage increases, supply power from the OBP 223_3 to the processing circuit 221_3 increases according to the increase of the application voltage.

Incidentally, this feedback processing using the target voltage controls the power supply such that the higher the target voltage is, the more the power is supplied from the OBP 223_3 to the processing circuit 221_3, whereas the lower the target voltage is, the less the power is supplied from the OBP 223_3 to the processing circuit 221_3.

In this embodiment, a target voltage for each plane 226_3 is calculated by taking the processing load in the processing circuit 221_3 of other plane 226_3 other than the calculation target into consideration as well, in the above-described feedback processing and feedforward processing. With this, it is possible to effectively avoid a situation in which the power supply to the first processing device 221_31 and the second processing device 221_32 in which processing is concentrated becomes insufficient due to an influence of a large processing load in the third processing device 221_33 through the fifth processing device 221_35 in which processing is rarely concentrated. Furthermore, it is possible to help the power supply to the first processing device 221_31 and the second processing device 221_32 by decreasing the power supply to the third processing device 221_33 through the fifth processing device 221_35 in which processing is rarely concentrated, when a processing load in the first processing device 221_31 and the second processing device 221_32 in which processing is concentrated and thus the shortage of power is expected.

As described above, according to this embodiment, by the feedback processing and the feedforward processing for the application voltage, and also by the feedback processing and the feedforward processing for the target voltage, power is adequately supplied to each processing circuit 221_3.

Incidentally, in the above description, as illustrated in FIG. 6, connection mode is exemplified in which five types of OBPs receive power supply from a not-illustrated common power supply via the power supply connector 212a in FIG. 4 and each OBP generates power to be supplied to the processing circuit. However, the present invention is not limited to this mode, and a connection mode of the OBPs may be another mode such as the following.

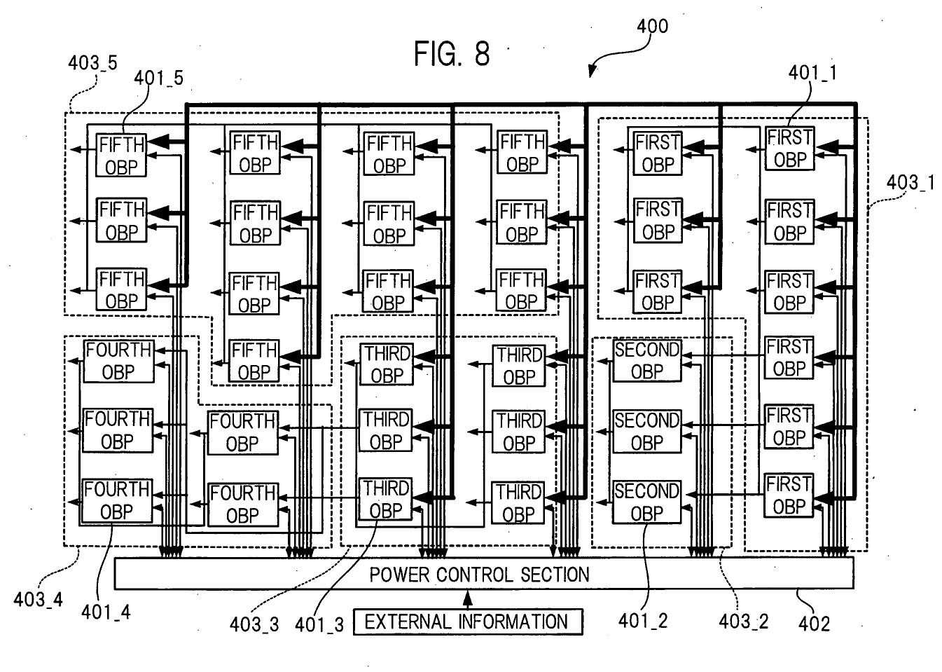

FIG. 8 illustrates one example of another connection mode of the OBPs, which is different from the connection mode illustrated in FIG. 6.

In a signal processing package 400 in FIG. 8, a second OBP 401_2 receives power supply from a first OBP 401_1 and generates an application voltage lower than that of the first OBP 401_1. A fourth OBP 401_4 receives power supply from a third OBP 401_3 and generates an application voltage lower than that of the third OBP 401_3. In such a circuit configuration, power supply of the second OBP 401_2 is strongly affected by fluctuations of a load in a not-illustrated first circuit to which the power is supplied from the first OBP 401_1. Similarly, the application voltage of the fourth OBP 401_4 is strongly affected by fluctuations of load in a not-illustrated third circuit to which the power is supplied from the third OBP 401_3. Here, each of the first OBP 401_1 and the third OBP 401_3 corresponds to one example of the first power supply according to the present invention, whereas each of the second OBP 401_2 and the fourth OBP 401_4 corresponds to one example of the second power supply according to the present invention.

Here, in the example of FIG. 8, a not-illustrated second circuit to which power is supplied from the second OBP 401_2 and a not-illustrated fourth circuit to which power is supplied from the fourth OBP 401_4 are processing circuits each of which handles communication processing, and processing is concentrated more in the second processing circuit than the not-illustrated first processing circuit to which the power is supplied from the first OBP 401_1 and also processing is more concentrated in the fourth processing circuit than the not-illustrated third processing circuit to which the power is supplied from the third OBP 401_3.

So, in the power control section 402 in FIG. 8, in the feedback processing in calculating a target voltage of the second plane 403_2, when a processing load of the first processing circuit is larger than a predetermined load, the target voltage is calculated to be rather high according to the difference between the detected processing load and the predetermined load. Here, the power control section 402 corresponds to one example of the power supply control section according to the present invention. Furthermore, in the feedback processing in calculating a target voltage of the first plane 403_1, when a processing load of the second processing circuit is larger than a predetermined load, the target voltage is calculated to be rather low according to the difference between the detected processing load and the predetermined load. Similarly, in the feedback processing in calculating a target voltage of the fourth plane 403_4, when a processing load of the third processing circuit is larger than a predetermined load, the target voltage is calculated to be rather high according to the difference between the detected processing load and the predetermined load.

Moreover, in the feedback processing in calculating a target voltage of the third plane 403_3, when a processing load of the fourth processing circuit is larger than a predetermined load, the target voltage is calculated to be rather low according to the difference between the detected processing load and the predetermined load.

Incidentally, in the power control section 402 in FIG. 8, in the feedforward processing in calculating a target voltage of the second plane 403_2, when a value of a current obtained from a current detection circuit in an upstream electrical interface package is larger than a predetermined value, the target voltage is calculated to be rather high according to the difference between the value of the current and the predetermined value. Further, in the feedback processing in calculating a target voltage of the first plane 403_1, when the above-described value of the current is larger than the predetermined value, the target voltage is calculated to be rather low according to the difference between the value of the current and the predetermined value. Similarly, in the feedforward processing in calculating a target voltage of the fourth plane 403_4, when a value of a current obtained from a current detection circuit in an upstream electrical interface package is larger than the predetermined value, the target voltage is calculated to be rather high according to the difference between the value of the current and the predetermined value. Moreover, in the feedback processing in calculating a target voltage of the third plane 403_3, when the above-described value of the current is larger than the predetermined value, the target voltage is calculated to be rather low according to the difference between the value of the current and the predetermined value.

Incidentally, regarding a processing load of a not-illustrated fifth processing circuit in which concentration of processing least occurs in the signal processing package 400, which fifth processing circuit is supplied with power from a fifth OBP 401_5 having no dependant relationship with other OBP, in the feedback processing in calculating a target voltage of each of the first plane 403_1 through the fourth plane 403_4, when the processing load is larger than a predetermined load, the target voltage is calculated to be rather high according to the difference between the processing load and the predetermined load.

Moreover, in the feedback processing in calculating a target voltage for the fifth plane 403_5 corresponding to the fifth OBP 401_5, when a processing load of the first through fourth processing circuits is larger than a predetermined load, the target value is calculated to be rather low according to the difference between each processing load and the predetermined load. In the feedforward processing in calculating a target voltage for the fifth plane 403_5, when a value of a current obtained from a current detection circuit in an upstream electrical interface package is larger than the predetermined value, the target value is calculated to be rather low according to the difference between the value of the current and the predetermined value.

Also in another mode of FIG. 8 explained above, it is possible to effectively avoid a situation in which the power supply to a processing device in which processing is concentrated becomes insufficient due to the influence of a large load in a processing device in which concentration of processing rarely occurs. Further, in a case where a power shortage is expected to happen in a processing device in which processing is concentrated, it is possible to help the power supply to the processing device in which processing is concentrated by decreasing power supply to a processing device in which concentration of processing rarely occurs.

Incidentally, in the above description, as one example of the power supply control section, the power control sections 224_3 and 402 that calculate a target voltage for each plane in accordance with a processing load in each processing device are described. However, the present invention is not limited to these power control sections. The power supply control section according to the present invention may have, for example, in a case where a relationship of extents of processing loads is fixed among plural processing devices, a fixed target voltage which has been calculated for each plane previously in the design stage by taking the fixed relationship of the extents into consideration, and controls supply power with the use of the fixed target voltage for each plane.

In addition, in the above-description, an explanation has been made about the example in which power to be supplied to a processing circuit is controlled by adjusting increase and decrease of a voltage to be applied to the processing circuit. However, the power supply control section according to the present invention may be one that controls power to be supplied to the processing circuit by adjusting an amount of a current to be supplied to the processing circuit.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A power supply device comprising:
a power supply section that receives supply of power and supplies the power to the outside thereof;
a plurality of power supplies which apply voltages to supply power, to each of a plurality of processing devices to perform processing by receiving application of a voltage and to include different types of application voltages planned to be applied, and each of the plurality of power supplies is supplied with power directly or indirectly from the power supply section; and
a power supply control section that increases and decreases supplying power to one processing device out of the plurality of processing devices according to an extent of a processing load in the one processing device as well as according to an extent of a processing load in another processing device whose application voltage is different from that of the one processing device.

2. The power supply device according to claim 1, wherein the power supply control section increases the supplying power to the one processing device, when the processing load in another processing device whose application voltage is different from that of the one processing device is larger than a predetermined load.

3. The power supply device according to claim 1, wherein the power supply control section decreases the supplying power to the one processing device, when the processing load in another processing device whose application voltage is different from that of the one processing device is larger than a predetermined load.

4. The power supply device according to claim 1, wherein the plurality of power supplies include:
a first power supply that is directly supplied with power from the power supply section; and
a second power supply that receives supply of power from the first power supply to apply a voltage lower than that of the first power supply to the one processing device, and
the power supply control section increases supplying power which the second power supply supplies to the one processing device, when the processing load in another processing device to which the first power supply supplies power is larger than a predetermined load.

5. The power supply device according to claim 1, wherein the plurality of power supplies include:
a first power supply that is directly supplied with power from the power supply section; and
a second power supply that receives supply of power from the first power supply to apply a voltage lower than that of the first power supply to the one processing device, and
the power supply control section decreases supplying power which the first power supply supplies to the one processing device, when the processing load in another processing device to which the second power supply supplies power is larger than a predetermined load.

6. An electronic apparatus comprising:
a plurality of processing devices each of which receives application of a voltage to perform processing, including different types of application voltages planned to be applied; and
a power supply device comprising:
a power supply section that receives supply of power and supplies the power to the outside thereof;
a plurality of power supplies which apply voltages to supply power, to each of the plurality of processing devices, and each of the plurality of power supplies is supplied with power directly or indirectly from the power supply section; and
a power supply control section that increases and decreases supplying power to one processing device out of the plurality of processing devices according to an extent of a processing load in the one processing device as well as according to an extent of a processing load in another processing device whose application voltage is different from that of the one processing device.
